(19) United States
(12) Patent Application Publication
(10) Pub. No.: US 2013/0305000 A1
(43) Pub. Date: Nov. 14, 2013

(54) SIGNAL PROCESSING CIRCUIT

(71) Applicant: ADVANTEST CORPORATION, Tokyo (JP)

(72) Inventor: Michisuke Sakamoto, Tokyo (JP)

(73) Assignee: ADVANTEST CORPORATION, Tokyo (JP)

(21) Appl. No.: 13/891,544

(22) Filed: May 10, 2013

(30) Foreign Application Priority Data
May 11, 2012 (JP) 2012-109897

(51) Int. Cl. G06F 12/00

(52) U.S. Cl. CPC G06F 12/00
USPC 711/154

(57) ABSTRACT

A memory controller is connected to memory, and has no ECC (Error Check and Correct) function. An embedded CPU is connected to the memory via the memory controller such that it can access the memory. A memory check circuit is connected to the memory via the memory controller such that it can access the memory, and configured to access the memory in the non-operating period of the embedded CPU, so as to check the data stored in the memory.

### BACKGROUND OF THE INVENTION

1. Field of the Invention

The present invention relates to a signal processing circuit.

2. Description of the Related Art

In recent years, in various kinds of signal processing circuits, an embedded processor is employed. FIG. 1 is a block diagram showing a first configuration of a signal processing circuit investigated by the present inventor. A signal processing circuit 1002a includes an embedded CPU (Central Processing Unit) 1004, a memory controller 1006, and memory 1008. The memory 1008 is configured to store a program to be executed by the CPU 1004. The embedded CPU 1004 is configured to fetch a command from the memory 1008, to execute the command, and to write data that corresponds to the execution result to a cache in the embedded CPU 1004 itself, or otherwise to the memory 1008, as necessary.

In some cases, the data stored in the memory 1008 is unintentionally damaged due to the effects of cosmic rays and the like. Such data damage is referred to as “soft error”. The memory controller 1006 shown in FIG. 1A does not have an ECC (Error Check and Correction) function. In this case, in a case in which the data stored in the memory 1008 is damaged, the embedded CPU 1004 is not capable of recognizing such data damage. For example, in a case in which the program region stored in the memory 1008 is damaged due to soft error, the embedded CPU 1004 operates abnormally. On the other hand, in a case in which the data generated by the embedded CPU 1004 is damaged, such an arrangement provides incorrect calculation results, which is a problem.

Such a problem can be solved by implementing an ECC function in the memory controller 1006 shown in FIG. 1. FIG. 2 is a block diagram showing a second configuration of a signal processing circuit investigated by the present inventor. The memory controller 1006 has an ECC function, which allows a soft error to be detected and corrected. As a result, such an arrangement allows the memory 1008 to maintain data with a correct value, thereby preventing the embedded CPU 1004 from operating abnormally.

However, in order to provide such an ECC operation with high efficiency, such an arrangement requires an additional data area to be used to perform the ECC operation, in addition to the data area required to allow the entire system 1002b to provide its own functions. Typically, in many cases, there is a demand for a system which requires only a low cost to employ such an embedded CPU. However, such an ECC function implemented in the system requires the memory 1008 to have a large capacity or an increased number of memory units, as compared with the configuration shown in FIG. 1 configured to perform an operation without involving an ECC operation, leading to increased costs. Specifically, an increase in the number of memory units requires an increase in the area of the printed circuit board for mounting the memory units, leading to increased costs. Furthermore, such an arrangement requires an increase in the number of pins, also leading to increased costs.

In addition, such an ECC function requires additional memory access for the ECC operation every time the embedded CPU 1004 accesses the memory 1008. Furthermore, such memory access requires the memory controller 1006 to perform pass/fail judgment, leading to increased latency in each bus access operation of the embedded CPU 1004. Typically, such an embedded CPU has inferior throughput per unit time as compared with a high-performance CPU. Thus, whether or not the ECC function is to be employed is decided based on the tradeoff between performance loss and the advantage of the ECC function.

### SUMMARY OF THE INVENTION

The present invention has been made in view of such a situation. Accordingly, it is an exemplary purpose of an embodiment of the present invention to provide a signal processing circuit configured to execute a memory check operation with a small load on an embedded CPU.

An embodiment of the present invention relates to a signal processing circuit. The signal processing circuit comprises: memory; a memory controller connected to the memory, and having no ECC (Error Check and Correct) function; an embedded processor connected to the memory via the memory controller such that it can access the memory; and a memory check circuit connected to the memory via the memory controller such that it can access the memory, and configured to access the memory in a non-operating period of the embedded processor so as to check data stored in the memory.

With such an embodiment, a memory check is performed when the embedded processor does not operate, i.e., in a period in which the embedded processor does not perform a memory access operation. Thus, such an arrangement provides reduced latency involved in the memory access operation of the embedded processor, thereby reducing the load on the embedded processor. In the present specification, examples of the embedded processor include an embedded CPU (Central Processing Unit), an embedded MPU (Micro Processing Unit), a processor built into an FPGA (Field Programmable Gate Array), and the like.

Also, the embedded processor may be configured to output, to the memory check circuit, a control signal which indicates whether the embedded processor is in an operating period or in a non-operating period. Such an arrangement allows the memory check circuit to execute a memory check operation according to a control signal received from the processor.

Also, the memory check circuit may be configured such that, when the embedded processor is in the non-operating period, it executes: generating an expected value by performing predetermined calculation processing on data to be checked that is stored in the memory; and generating an evaluation value by performing the predetermined calculation processing on data stored in the memory for each predetermined check cycle, so as to compare the evaluation value with the expected value.

Also, the memory check circuit may be configured to write the expected value to the memory.

With an another embodiment, the memory check circuit may be configured to write the expected value to a register that differs from the memory. Such an arrangement is capable of reducing the memory access involved in the memory check operation.

Also, a data area to be checked by the memory check circuit may be settable. Thus, such an arrangement is applicable to various kinds of systems.

Also, the check cycle may be settable. By shortening the check cycle, such an arrangement provides improved reliability, and by lengthening the check cycle, such an arrangement is capable of saving the resources assigned to the memory check operation.

Also, the expected value and the evaluation value may be each defined as the sum of the bits of the data to be checked. Such an arrangement provides a reduction in a storage area required to store the expected value.

Also, the expected value and the evaluation value may be each defined as the data to be checked itself. Such an arrangement allows a bitwise comparison to be made, thereby providing a high-precision error check operation.

Also, in a case in which the data to be checked has a fixed value, the memory check circuit may be configured to generate the expected value once, after the data is first written to the memory.

Also, when an error is detected in the data stored in the memory, the memory check circuit may be configured to correct the data stored in the memory.

Also, the signal processing circuit may further comprise a host processor connected to the memory via the memory controller such that it can access the memory, and configured to write, to the memory, a program to be executed by the embedded processor. Also, when the memory check circuit detects an error, the host processor may be configured to write the program to the memory again.

Such an arrangement is capable of maintaining the contents of the memory in a normal state.

Another embodiment of the present invention relates to a test apparatus for a semiconductor device. The test apparatus comprises a signal processing circuit according to any one of the aforementioned embodiments. Such an arrangement is capable of preventing the embedded processor from operating abnormally, thereby allowing a device to be tested with high precision.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram showing a first configuration of a signal processing circuit investigated by the present inventor;

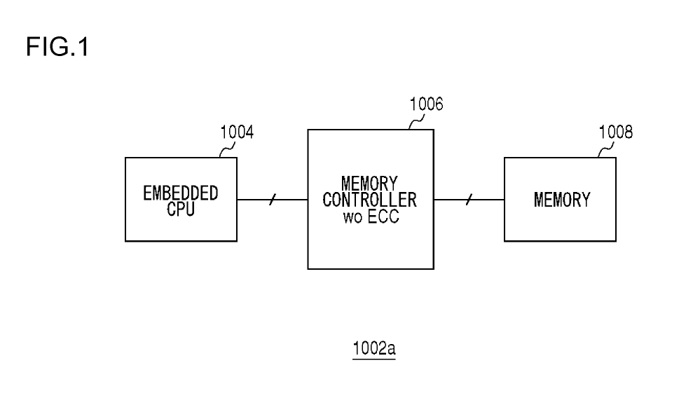

FIG. 2 is a block diagram showing a second configuration of a signal processing circuit investigated by the present inventor;

FIG. 3 is a block diagram showing a configuration of a signal processing circuit according to an embodiment;

FIG. 4 is a flowchart showing a memory check operation executed by a memory check circuit;

FIGS. 5A through 5C are diagrams each showing memory state transition in the expected value generating operation;

FIG. 6 is a time chart showing a memory check operation executed by the memory check circuit; and

FIG. 7 is a block diagram showing a configuration of a signal processing circuit according to a second embodiment.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

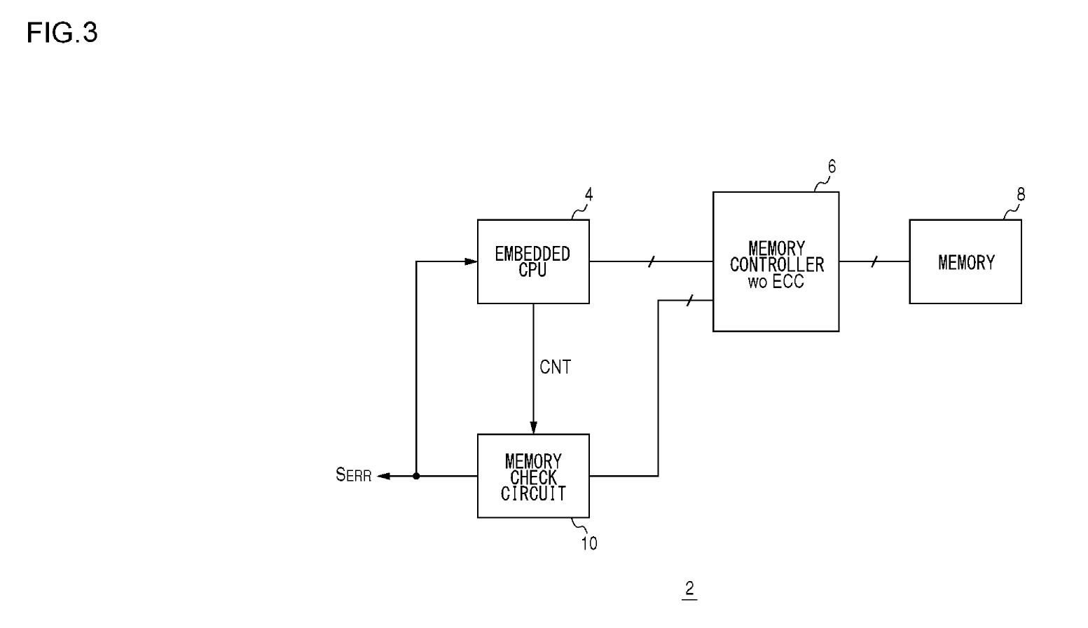

FIG. 3 is a block diagram showing a configuration of a signal processing circuit 2 according to an embodiment. The signal processing circuit 2 includes an embedded CPU 4, a memory controller 6, memory 8, and a memory check circuit 10. A part of or otherwise all of the embedded CPU 4, the memory controller 6, and the memory check circuit 10 may be integrated in the form of a single semiconductor chip or a module.

The memory 8 is configured to store a program to be executed by the embedded CPU 4, intermediate data generated in a data processing operation of the embedded CPU 4, and the like. Furthermore, the memory 8 is configured to store an expected value generated by the memory check circuit 10 as described later.

The memory controller 6 is connected to the memory 8. The memory controller 6 is configured as an interface circuit between the memory 8 and the circuits other than the memory 8. With the present embodiment, the memory controller 6 does not have an ECC (Error Check and Correct) function.

The embedded CPU 4 is connected to the memory 8 via the memory controller 6 such that it can access the memory 8. The embedded CPU 4 is configured to read out a program stored in the memory 8, and to execute the program thus read out. Furthermore, the embedded CPU 4 instructs the memory 8 to store intermediate data generated as necessary. Specifically, the program to be executed by the embedded CPU 4 is stored in a fixed value area of the memory 8. The data having a value to be rewritten by the embedded CPU 4 is stored in a variable value area of the memory 8.

The memory check circuit 10 is connected to the memory 8 via the memory controller 6 such that it can access the memory 8, in the same way as the embedded CPU 4. The memory check circuit 10 is configured to access the memory 8 in a non-operating period of the embedded CPU 4, and to check the data stored in the memory 8. When the memory check circuit 10 detects an error, the memory check circuit 10 asserts an interrupt signal S_{ERR} configured as an error detection notice to be transmitted to the embedded CPU 4 or otherwise an external unit.

The embedded CPU 4 is configured to repeat an operating period and a non-operating period in a time sharing manner, and to output, to the memory check circuit 10, a control signal CNT which indicates whether the embedded CPU 4 is in the operating period or the non-operating period. In the operating period, the embedded CPU 4 executes a program command, which enables access to the memory by the embedded CPU 4. On the other hand, in the non-operating period, the embedded CPU 4 suspends an operation that is executed according to the program, which disables access to the memory by the embedded CPU 4. That is to say, the non-operating period corresponds to an idle state in which the embedded CPU 4 is standing by for an external instruction.

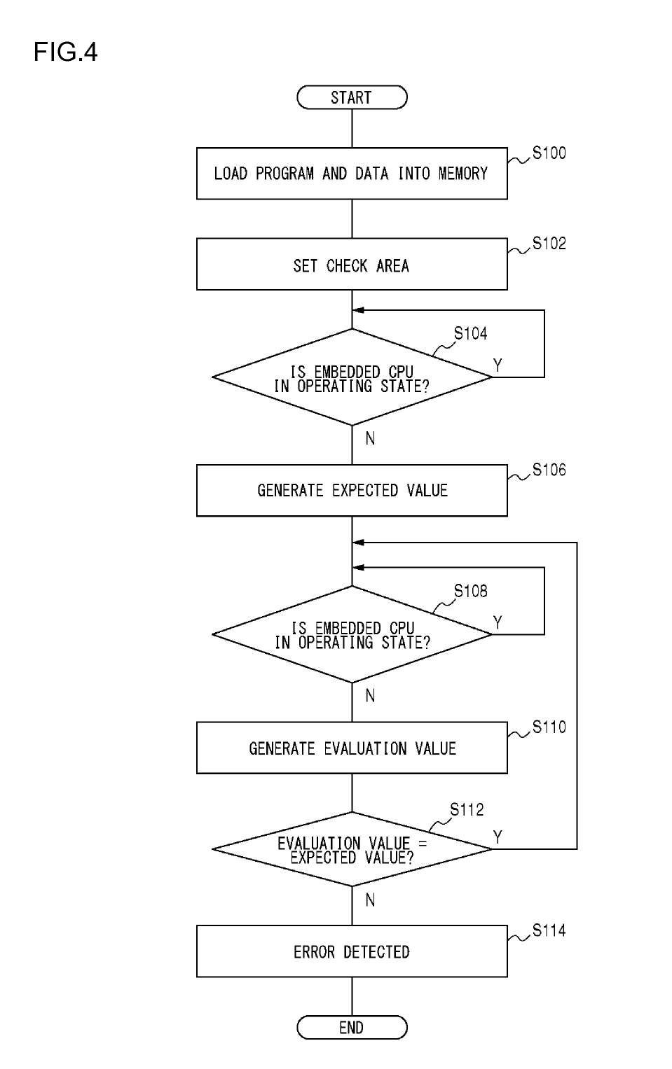

Specific description will be made regarding the memory check operation performed by the memory check circuit 10. FIG. 4 is a flowchart showing the memory check operation performed by the memory check circuit 10.

After the signal processing circuit 2 is started up, a program to be executed by the embedded CPU 4 is loaded into a predetermined area of the memory 8, and a predetermined data area is allocated to the embedded CPU 4 (S100).

Subsequently, a target region to be checked by the memory check circuit 10 is selected from the data stored in the memory 8 (S102). The target area to be checked, and specifically the number of or the range of data items to be checked, can be set as desired according to an external instruction. That is to say, the target area to be checked is changed as appropriate according to the kind of program or data loaded into the memory 8.

Subsequently, judgment is made based on the control signal CNT of whether the embedded CPU 4 is in the operating period or in the non-operating period (S104). When the embedded CPU 4 is in the operating period (YES in S104), the memory check circuit 10 enters the idle state. When the embedded CPU 4 is in the non-operating period (NO in S104), the memory check circuit 10 reads out the data stored in the area to be checked, and performs predetermined calculation processing on the data thus read out so as to generate an expected value (S106). The expected value is generated once, after the data is first written to the memory 8. Subsequently, the same expected value is repeatedly used.

The method for generating such an expected value is not restricted in particular. For example, the memory check circuit 10 may be configured to calculate the sum of all the bits included in the data to be checked, and to use the sum thus calculated as an expected value. The expected value thus generated is written to the memory 8.

Subsequently, judgment is made based on the control signal CNT of whether the embedded CPU 4 is in the operating period or in the non-operating period (S108). When the embedded CPU 4 is in the operating period (YES in S108), the memory check circuit 10 enters the idle state. When the embedded CPU 4 is in the non-operating period (NO in S108), the memory check circuit 10 reads out the data from the area to be checked, and performs the same calculation processing on the data thus read out as that which was used to generate the expected value so as to generate an evaluation value (S110).

Subsequently, the memory check circuit 10 compares the evaluation value with the expected value (S112). If the data stored in the memory 8 is not damaged, the expected value matches the evaluation value. When the expected value matches the evaluation value (YES in S112), the flow returns to the processing at S108. When the expected value does not match the evaluation value (NO in S112), an error is detected (S114). The notice that such an error has been detected is transmitted to the embedded CPU 4 and/or a different unit, and necessary processing is performed.

It should be noted that, in a case in which a flag is asserted which indicates the operating state of the embedded CPU 4 partway through the memory check operation of the memory check circuit 10, and specifically partway through Step S110 or Step S112, the memory check circuit 10 temporarily suspends the memory check operation at that time point, and enters the idle state until a flag which indicates the non-operating state of the embedded CPU 4 is asserted. Subsequently, when the flag which indicates the non-operating state of the embedded CPU 4 is asserted, the memory check circuit 10 resumes the suspended operation.

The memory check circuit 10 is configured to generate an evaluation value for each predetermined check cycle, and to compare the evaluation value thus generated with the expected value. The check cycle length can be set as desired by the designer of the signal processing circuit 2.

The above is the configuration of the signal processing circuit 2. Next, description will be made regarding the operation thereof.

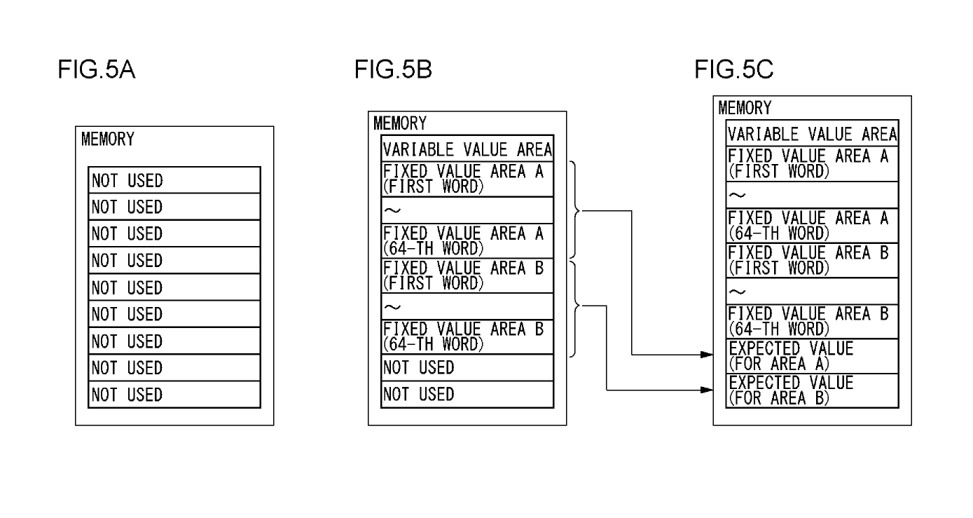

FIGS. 5A through 5C are diagrams showing state transitions of the memory 8 for generating the expected value.

Immediately after the signal processing circuit 2 is started up, as shown in FIG. 5A, the memory 8 stores no data and no program. FIG. 5B shows the state in which a program is loaded into the memory 8. In this example, the first word is allocated as the variable value area, and the subsequent consecutive 128 words are allocated as the fixed value area.

Subsequently, the data area to be checked by the memory check circuit 10 is specified. The number of data areas and the length (the number of words) of each data item can be set as desired. In this example, a variable value area having a data length of 128 words is divided into the first 64 words and the subsequent 64 words, which are set to a data area A and a data area B, respectively. Subsequently, the expected values are generated for the respective data regions A and B. The expected values thus generated are stored in a part of the memory 8, as shown in FIG. 5C.

Subsequently, the memory check circuit 10 repeatedly executes the processing in S110 and S112 shown in FIG. 4 for each predetermined check cycle, so as to detect whether or not an error has occurred in each of the data areas A and B.

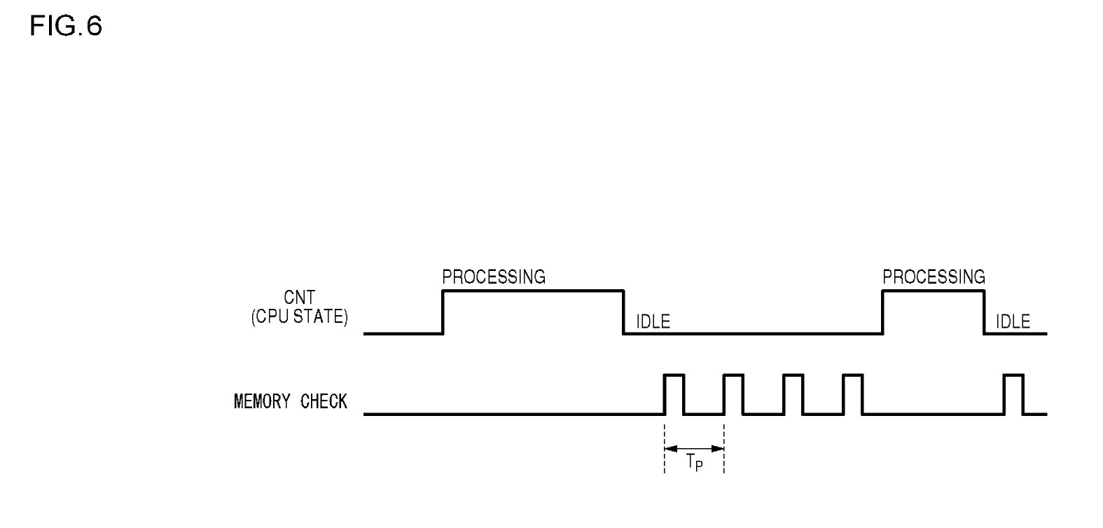

FIG. 6 is a time chart showing the memory check operation (S110 and S112) performed by the memory check circuit 10. The high-level state of the control signal CNT corresponds to the operating state of the embedded CPU 4, and its low-level state corresponds to the non-operating state of the embedded CPU 4. On the other hand, the high-level state of a memory check signal corresponds to a state in which the memory check operation (S110 and S112) is performed. As shown in FIG. 6, in the non-operating period of the embedded CPU 4 after the expected value is generated, the memory check operation is performed for each predetermined check cycle Tp. During the operating period of the embedded CPU 4, the memory check operation is not performed.

The above is the operation of the signal processing circuit 2. Next, description will be made regarding the advantages of the signal processing circuit 2.

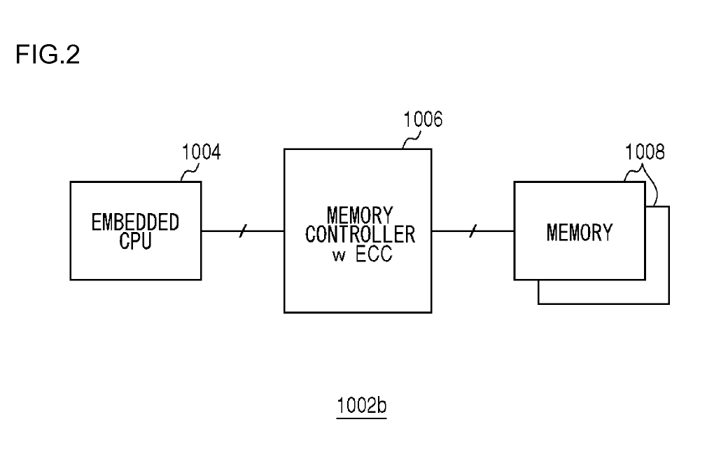

With the architecture shown in FIG. 2, in the memory access operation of the embedded CPU 4, an error is directly detected and corrected in a real time manner. In contrast, with the signal processing circuit 2 according to the embodiment, the memory check operation of the memory check circuit 10 is performed in a concentrated manner in a period in which the embedded CPU 4 does not operate, i.e., in a period in which the embedded CPU 4 does not access the memory. In this respect, it can be said that the signal processing circuit 2 is configured to perform an indirect memory check operation. As a result, during a period in which the embedded CPU 4 accesses the memory, such an arrangement does not involve data access that relates to the memory check operation. Thus, such an arrangement provides reduced latency, thereby reducing the load of the embedded CPU 4.

Furthermore, the signal processing circuit 2 allows an additional data area required for the error check operation to be reduced, as compared with conventional ECC techniques. As a result, such an arrangement allows the required memory capacity and the required number of memory units to be reduced, thereby suppressing an increase in costs. In particular, as compared with a system employing a high-performance CPU, with a system employing such an embedded CPU 4, from the viewpoint of costs and the required circuit area, there is a strong demand for the memory capacity to be the smallest possible, and the signal processing circuit 2 according to the embodiment is suitably employed in such an application.

Ideally, it is preferable for the memory check circuit 10 to check all the data stored in the memory 8. However, realistically, the processing speed of the memory check circuit 10, i.e., the throughput of the memory check circuit 10, is limited. Thus, in some cases, it is difficult to check all the data in a limited period of time in which the embedded CPU 4 is in the non-operating state. Such a problem can be solved by configuring the data area to be checked such that it can be set as desired. For example, in a case in which the memory 8 has a large memory capacity, which leads to difficulty in checking the entire area of the memory 8 due to the limited resources of the memory check circuit 10, such an arrangement may preferably be configured to check, with a higher priority level, the data that can lead to serious effects if it is damaged, i.e., the data required to have high reliability. In some cases, there is a great difference in the disposition of data loaded into the memory 8 among the programs executed by the signal processing circuit 2. Even in such a case, such an arrangement is capable of appropriately setting the data area to be checked.

Such an arrangement is capable of selecting the data area to be checked with high flexibility. Thus, such an arrangement is applicable to various kinds of systems.

In addition, the memory check circuit 10 is configured to be capable of setting the check cycle. Thus, in a case in which the memory check circuit 10 has sufficient processing speed, the check cycle is shortened, thereby improving the reliability, and in a case in which the memory check circuit 10 does not have sufficient processing speed, such an arrangement is capable of increasing the check cycle.

Also, in a case in which multiple data areas are each set as target data to be checked, such an arrangement is capable of relatively shortening the check cycle for a data area required to have high reliability, as compared with the other data areas.

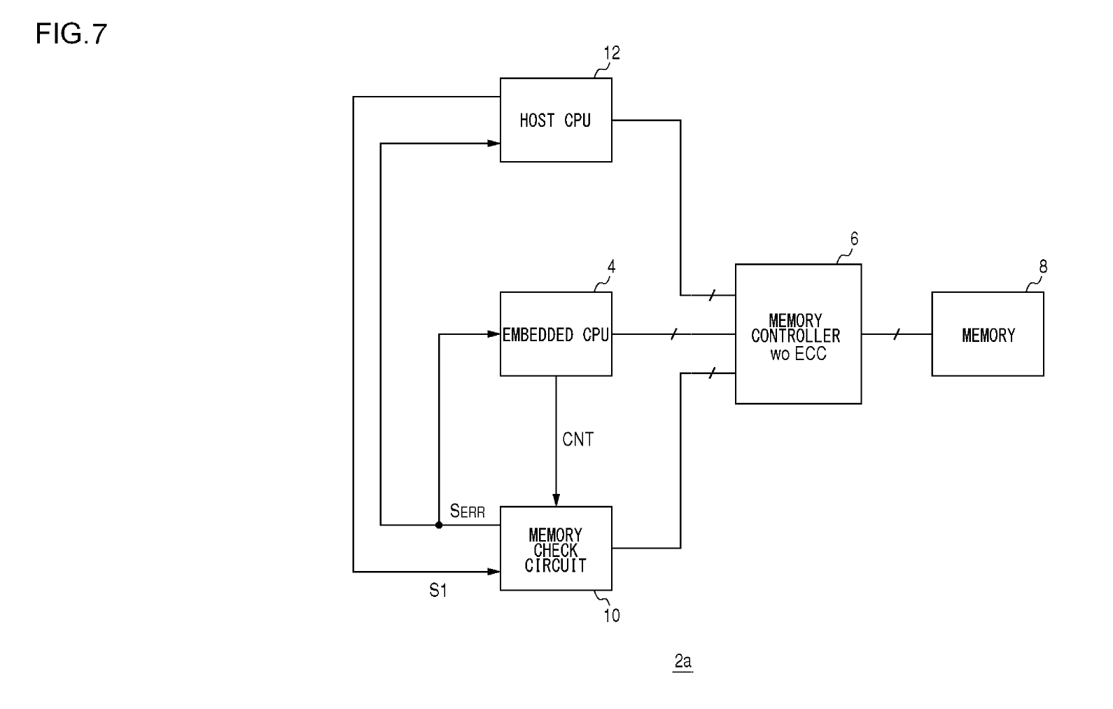

Lastly, description will be made regarding an application of the signal processing circuit 2. The signal processing circuit 2 may be applied to a desired signal processing system. For example, the signal processing circuit 2 shown in FIG. 3 or FIG. 7 is applicable to a semiconductor test apparatus (which will be referred to simply as a “test apparatus”). Thus, by detecting a soft error that has occurred in the memory 8, and by executing a suitable operation when such a soft error is detected, such an arrangement is capable of preventing the embedded CPU 4, i.e., the test apparatus configured as an entire system, from operating abnormally.

Description has been made regarding the present invention with reference to the embodiment. The above-described embodiment has been described for exemplary purposes only, and is by no means intended to be interpreted restrictively. Rather, it can be readily conceived by those skilled in this art that various modifications may be made by making various combinations of the aforementioned components or processes, which are also encompassed in the technical scope of the present invention. Description will be made below regarding such modifications.

### [First Modification]

Description has been made regarding the memory check circuit 10 shown in FIG. 3 configured to detect an error that has occurred in the memory 8, and to notify the embedded CPU 4 or the like of this error. In contrast, with a first modification, the memory check circuit 10 is configured to correct the data stored in the memory 8 when the memory check circuit 10 detects an error in the data stored in the memory 8. That is to say, an ECC function is implemented in the memory check circuit 10. The memory 8 is configured to store data required for the ECC function such as a redundant bit to be used for error correction or the like, in addition to an expected value.

When an error is detected in the memory check operation, the memory check circuit 10 performs error correction so as to write correct data to the memory 8. With the first modification, the memory check circuit 10 is configured to access the memory 8 in a limited period of time in which the embedded CPU 4 does not operate. Thus, such an arrangement provides reduced latency required for the memory access operation of the embedded CPU 4.

### [Second Modification]

FIG. 7 is a block diagram showing a configuration of a signal processing circuit 2a according to a second modification. The signal processing circuit 2a further includes a host CPU 12 in addition to the signal processing circuit 2 shown in FIG. 3.

The host CPU 12 is connected to the memory 8 via the memory controller 6 such that it can access the memory 8. The host CPU 12 is configured to load a program to be executed by the embedded CPU 4 into the memory 8. When the memory check circuit 10 detects an error, the host processor 12 writes the program to the memory 8 again. Such a modification allows the data stored in the memory 8 to be replaced by a correct value when an error occurs.

With such a modification, the host CPU 12 has information with respect to the address in the memory 8 into which each data item is loaded, and the information with respect to the respective data items to be loaded into the respective addresses. Thus, the host CPU 12 may be configured to generate data S1 which indicates the data area to be checked by the memory check circuit 10, and/or data which specifies the check cycle, and to transmit the data thus generated to the memory check circuit 10. Such a configuration allows the memory check operation of the memory check circuit 10 to be optimized.

### [Third Modification]

Description has been made in the embodiment regarding an arrangement in which an expected value generated in the first stage is repeatedly used. Also, the expected value may be periodically updated at a rate that is lower than the check cycle.

### [Fourth Modification]

Description has been made in the embodiment regarding an arrangement in which the sum of bits stored in the data area to be checked is used as an expected value. However, the present invention is not restricted to such an arrangement. For example, the data stored in the data area to be checked may be used as it is as an expected value and an evaluation value. Although such an arrangement requires an increased memory capacity, such an arrangement provides high-precision error detection.

### [Fifth Modification]

Description has been made in the embodiment regarding an arrangement in which, when the embedded CPU 4 transits to an operating state partway through the memory check operation of the memory check circuit 10, the memory check operation is suspended. Conversely, when the embedded CPU 4 transits to an operating state partway through the memory check operation of the memory check circuit 10, the embedded CPU 4 may be configured to start the memory access operation after the memory check operation is completed.

### [Sixth Modification]

Description has been made in the embodiment regarding an arrangement in which the memory check circuit 10 is configured to judge whether or not the embedded CPU 4 is in the operating state based on the control signal CNT received from the embedded CPU 4. However, the present invention is not restricted to such an arrangement. In a case in which the operating state of the embedded CPU 4 is controlled by the host CPU 12 in the signal processing circuit 2a shown in FIG. 7, the host CPU 12 may be configured to generate the control signal CNT.

Description has been made regarding the present invention with reference to the embodiments. However, the above-described embodiments show only the mechanisms and applications of the present invention for exemplary purposes only, and are by no means intended to be interpreted restrictively. Rather, various modifications and various changes in the layout can be made without departing from the spirit and scope of the present invention defined in appended claims.

What is claimed is:

1. A signal processing circuit comprising:
memory;
a memory controller connected to the memory, and having no ECC (Error Check and Correct) function;
an embedded processor connected to the memory via the memory controller such that it can access the memory; and
a memory check circuit connected to the memory via the memory controller such that it can access the memory, and configured to access the memory in a non-operating period of the embedded processor so as to check data stored in the memory.

2. The signal processing circuit according to claim 1, wherein the embedded processor is configured to output, to the memory check circuit, a control signal which indicates whether the embedded processor is in an operating period or in a non-operating period.

3. The signal processing circuit according to claim 1, wherein the memory check circuit is configured such that, when the embedded processor is in the non-operating period, it executes:
generating an expected value by performing predetermined calculation processing on data to be checked that is stored in the memory; and
generating an evaluation value by performing the predetermined calculation processing on data stored in the memory for each predetermined check cycle, so as to compare the evaluation value with the expected value.

4. The signal processing circuit according to claim 3, wherein the memory check circuit is configured to write the expected value to the memory.

5. The signal processing circuit according to claim 3, wherein the memory check circuit is configured to write the expected value to a register that differs from the memory.

6. The signal processing circuit according to claim 1, wherein a data area to be checked by the memory check circuit is settable.

7. The signal processing circuit according to claim 3, wherein the check cycle is settable.

8. The signal processing circuit according to claim 3, wherein the expected value and the evaluation value are each defined as the sum of the bits of the data to be checked.

9. The signal processing circuit according to claim 3, wherein the expected value and the evaluation value are each defined as the data to be checked itself.

10. The signal processing circuit according to claim 3, wherein, in a case in which the data to be checked has a fixed value, the memory check circuit is configured to generate the expected value once, after the data is first written to the memory.

11. The signal processing circuit according to claim 1, wherein, when an error is detected in the data stored in the memory, the memory check circuit is configured to correct the data stored in the memory.

12. The signal processing circuit according to claim 1, further comprising a host processor connected to the memory via the memory controller such that it can access the memory, and configured to write, to the memory, a program to be executed by the embedded processor,
wherein, when the memory check circuit detects an error, the host processor is configured to write the program to the memory again.

13. The signal processing circuit according to claim 1, further comprising a host processor connected to the memory via the memory controller such that it can access the memory, and configured to write, to the memory, a program to be executed by the embedded processor,
wherein the host processor is configured to output, to the memory check circuit, a control signal which indicates whether the embedded processor is in the operating period or in the non-operating period.

14. A test apparatus comprising a signal processing circuit, wherein the signal processing circuit comprises:
memory;
a memory controller connected to the memory, and having no ECC (Error Check and Correct) function;
an embedded processor connected to the memory via the memory controller such that it can access the memory; and
a memory check circuit connected to the memory via the memory controller such that it can access the memory, and configured to access the memory in a non-operating period of the embedded processor so as to check data stored in the memory.
